(19) United States
(12) Patent Application Publication
(10) Pub. No.: US 2025/0142677 A1
(43) Pub. Date: May 1, 2025

(54) ELECTRIC HEATER FOR HEATING A HYDROCARBON PROCESS STREAM

(71) Applicant: UOP LLC, Des Plaines, IL (US)

(72) Inventors: Sean Dalton, New Haven, CT (US); Aziz Sattar, Itasca, IL (US); Trung Pham, Mount Prospect, IL (US); Pengfei Chen, Buffalo Grove, IL (US); Nitin P. Chitgopekar, Hoffman Estates, IL (US); Jennifer J. Ozmen, Wilmette, IL (US); Phillip F. Daly, Palatine, IL (US)

(21) Appl. No.: 18/802,063

(22) Filed: Aug. 13, 2024

Related U.S. Application Data
(60) Provisional application No. 63/593,856, filed on Oct. 27, 2023.

(51) Int. Cl. H05B 3/42; H05B 3/12

(52) U.S. Cl. CPC H05B 3/42; H05B 3/12; H05B 2203/005; H05B 2203/012; H05B 2203/022; H05B 2214/03

(57) ABSTRACT

Electric heaters for heating a hydrocarbon process stream. The electric heater has a cavity with parallel walls which may provide a rectangular cross section to the cavity. The parallel side walls may be parallel to a longitudinal axis of the electrical heating elements which extend into the cavity to transfer heat to fluid passing there through. Various configurations and orientations of the electrical heating elements are provided.

### CROSS-REFERENCES TO RELATED APPLICATIONS

This application claims the benefit of U.S. Provisional Patent Application Ser. No. 63/593,856 filed on Oct. 27, 2023, the entire disclosure of which is incorporated herein by way of reference.

### FIELD OF THE INVENTION

This invention relates generally to an electric heater for heating hydrocarbon process stream.

### BACKGROUND OF THE INVENTION

There is increased focus on reducing fossil fuel consumption, improving efficiencies to reduce carbon dioxide footprint, and increasing dependency on renewable sources of energy. With the pivoting of the refining and petrochemical industries towards sustainable sources of energy like solar, wind, hydroelectric, nuclear, etc. and the making of more green electricity available, there is a desire to reduce the size of fired heaters for technologies like hydrocarbon reforming, dehydrogenation, isomerization, transalkylation, hydrotreating, and others.

Process heating of a feed stream is generally done by fired heating or by circulation of hot heat transfer fluid in contact with metallic conduit/vessel/pipe containing the pressurized feed. This heating itself generates carbon dioxide from combustion of hydrocarbon rich fuel gas There are many thermal resistances to efficient heat transfer between the heating sources and feed to be heated. In case of fired heating, only 60% of thermal energy generated by combustion is transferred to process feed. Fired heating can also create hot spots as heat flux imparted to metallic conduit/vessel/pipe containing the pressurized feed is often non-uniform heat due to proximity of flame front and conduit/vessel/pipe. The hot spot in metallic conduit/vessel/pipe can increase potential of metal catalyzed coking of feed. Additionally, fired heating itself generates carbon dioxide from combustion of hydrocarbon rich fuel gas.

Recently, the use of electric heaters in hydrocarbon processing has been proposed. While presumably effective for their intended purposes, it is believed that newer and better heater designs will increase the effectiveness and efficiency of the electric heaters in hydrocarbon processing processes.

Thus, the present invention provides devices and processes which provide more effective and efficient ways to heat process streams with electric heaters.

### SUMMARY OF THE INVENTION

The present inventors have invented new designs for electric heaters and the electrical heating elements associated with same.

The present invention may be characterized, in at least one aspect, as providing an electric heater for heating a fluid stream having: a body with an inlet and an outlet and a cavity between the inlet and outlet; and, a plurality of electrical heating elements extending into the cavity, the electrical heating elements arranged along a direction of flow from the inlet to the outlet. At least some of the electrical heating elements are configured to be operated independently of the remaining electrical heating elements. The cavity comprises a first side wall that extends parallel to a second side wall.

A heat flux of the electrical heating elements may decreases in the direction of flow such that an electrical heating element closer to the inlet has a higher heat flux compared to an electrical heating element farther from the inlet.

Electric heating elements closest to the inlet may have a lower heat flux than the other electric heating elements.

Electric heating elements closest to side walls of the cavity may have a lower heat flux than the other electric heating elements.

The first and second side walls may be planar.

The cavity may have a cross sectional shape along the direction of flow that is rectangular.

An outer shape of the body may be circular.

One or more of the electrical heating elements may have an outer surface that includes a plurality of detents.

One or more of the electrical heating elements may include: a heat generating substrate; a packing material surrounding the heat generating substrate; a sheath surrounding the packing material; and a longitudinal axis. The packing material may be divided, when viewed along the longitudinal axis, into a plurality of thermal conductivity zones, with adjacent thermal conductivity zones having different thermal conductivity levels. The thermal conductivity zones may be arranged such that a horizontal cross section, when viewed along the longitudinal axis, is a mirror image. The thermal conductivity zones may be arranged to have an increasing thermal conductivity.

One or more of the electrical heating elements may include: a heat generating substrate; a packing material surrounding the heat generating substrate; a sheath surrounding the packing material; and a longitudinal axis. The sheath may have, when viewed along the longitudinal axis, a circular cross section, and the heat generating substrate may have, when viewed along the longitudinal axis, a non-circular cross section. Alternatively, the sheath may have, when viewed along the longitudinal axis, a non-circular cross section, and the heat generating substrate may have, when viewed along the longitudinal axis, a circular cross section. It is contemplated that a distance from an outer surface of the heat generating substrate to an inner surface of the sheath, when viewed along the longitudinal axis, is non-constant.

The electrical heating elements may be arranged into a rectangular orientation.

Each electrical heating element may include a heat generating substrate and a sheath surrounding the heat generating substrate. The sheath may have a FeCrAl alloy forming an outer surface.

At least one internal surface of the electric heater may include or be formed from a 347AP stainless steel. Each electrical heating element may include a heat generating substrate and a sheath surrounding the heat generating substrate. The sheath may include the 347AP stainless steel.

A pitch between electrical heating elements may change along the direction of flow.

A pitch, in a rectangular orientation, between electrical heating elements may be between 0.25 inches to 12 inches, for example, 0.5 inches.

The electrical heating elements may be arranged in bundles, and at least two bundles may be configured to be operated together.

The electrical heating elements may have different directions of insertion into the cavity. For example, the directions of insertion may alternate for adjacent electrical heating elements. The directions of insertion, when viewed along the direction of flow, may rotate by between 1 to 179 degrees, or between 20 to 160 degrees, or approximately 90 degrees.

The direction of flow in the electric heater may be radially inward or radially outward.

The electric heater may also include at least one temperature sensor configured to obtain a temperature measurement associated with the electric heater.

At least one internal surface of the electric heater may be coated with an aluminum coating.

Each electrical heating element may include a heat generating substrate and a sheath surrounding the heat generating substrate. An aluminum-containing barrier coating may be applied to the sheath.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

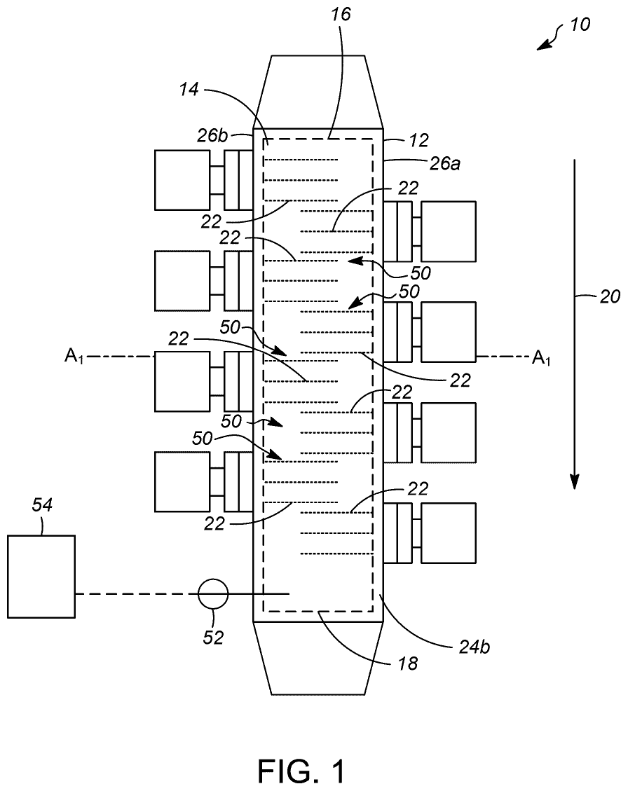

FIG. 1 shows a side view of an electric heater according to one or more aspects of the present invention;

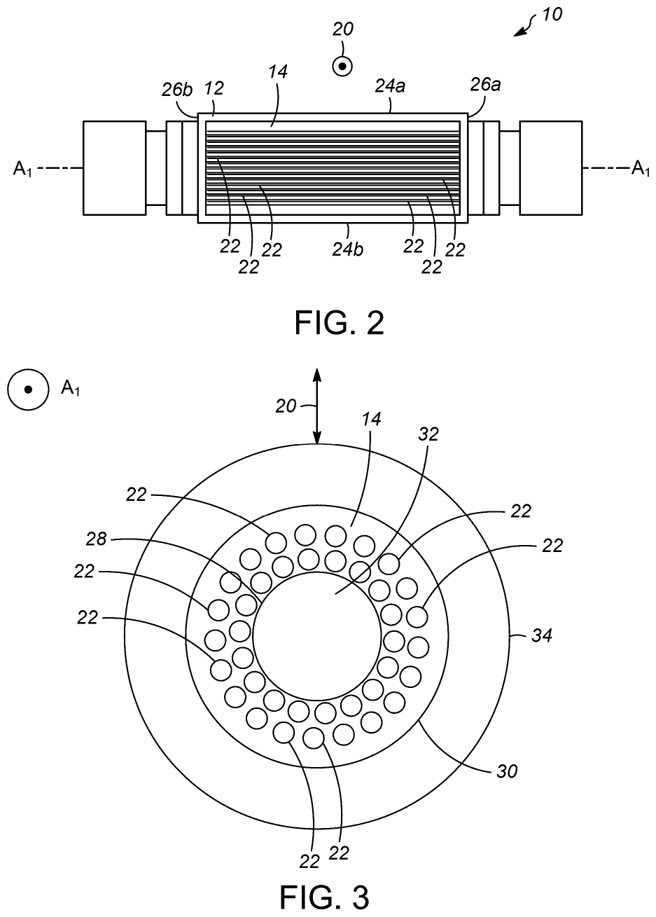

FIG. 2 shows a top, cutaway view of the electric heater shown in FIG. 1;

FIG. 3 shows a top, cutaway view of an electric heater according to one or more aspects of the present invention;

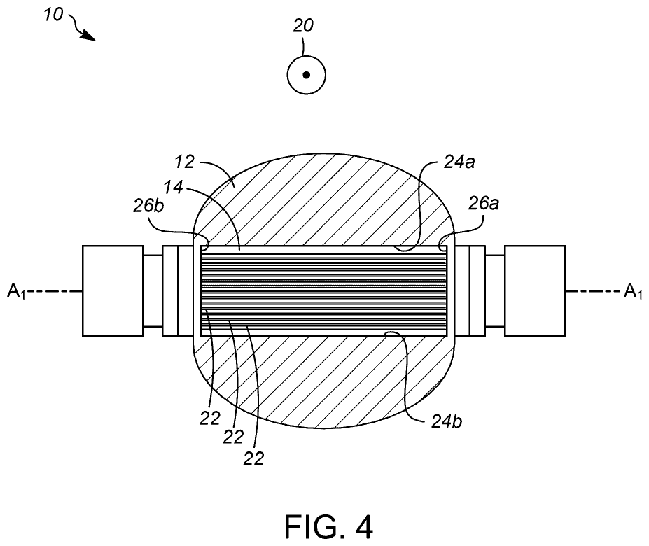

FIG. 4 shows a top, cutaway view of another electric heater according to one or more aspects of the present invention;

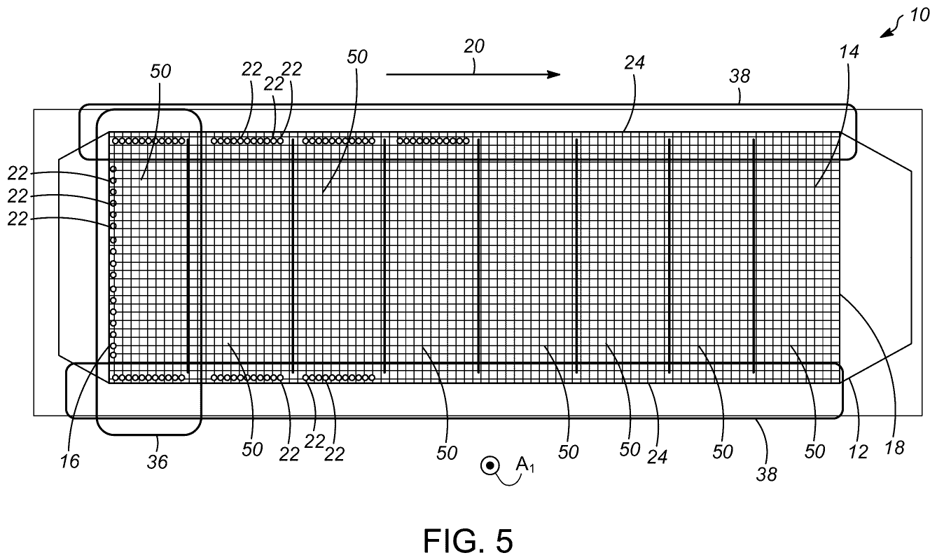

FIG. 5 shows a side, cutaway view of a further electric heater according to one or more aspects of the present invention;

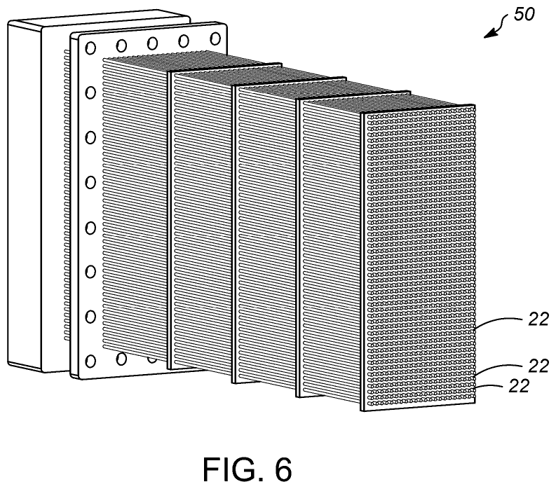

FIG. 6 shows a front and side view of a bundle of electric heating elements according to one or more aspects of the present invention;

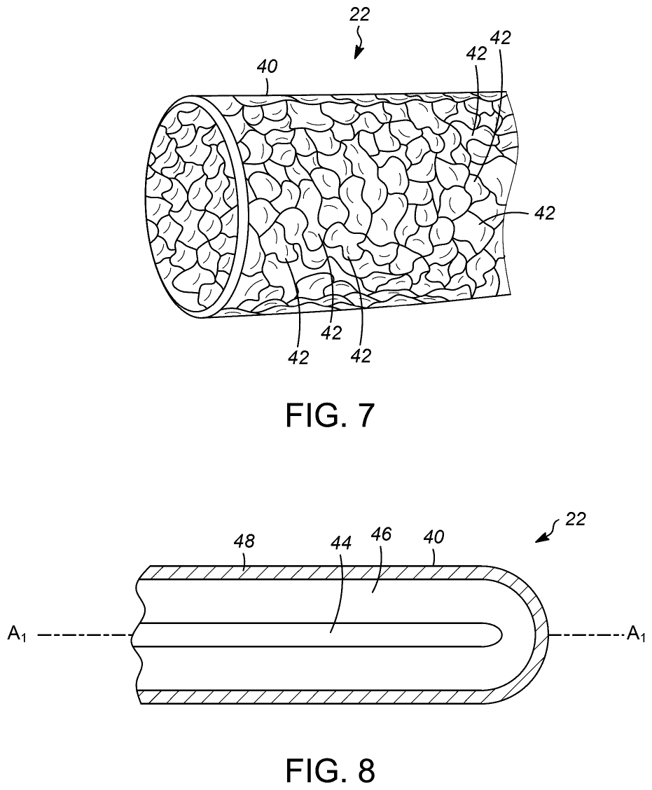

FIG. 7 shows a side view of an outer surface of an electric heating element according to one or more aspects of the present invention;

FIG. 8 is a side, cut away view of an electric heating element according to one or more aspects of the present invention;

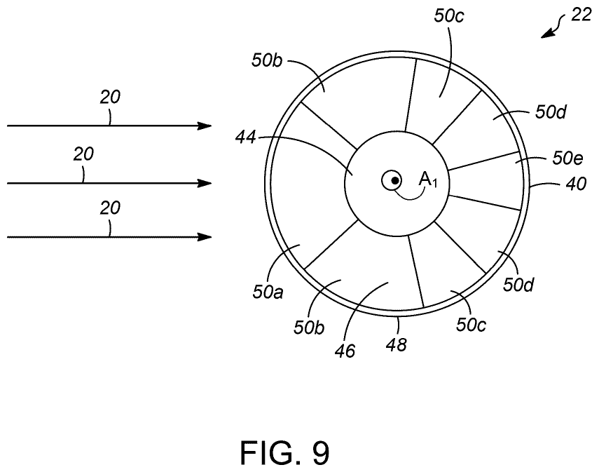

FIG. 9 is a front, cut away view of the electric heating element of FIG. 8;

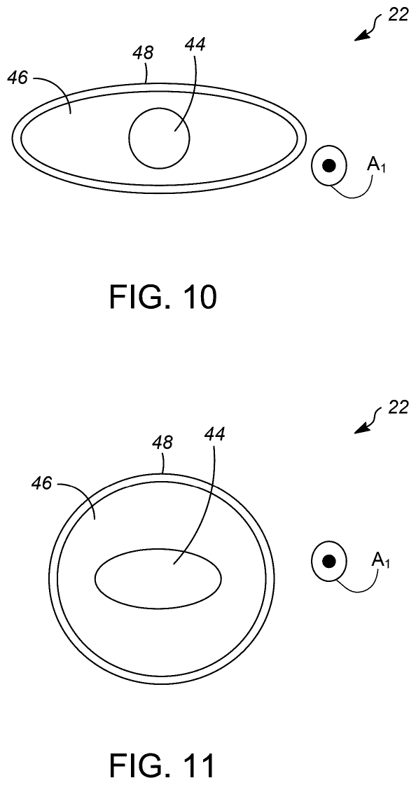

FIG. 10 is a front, cut away view of an electric heating element according to one or more aspects of the present invention;

FIG. 11 is a front, cut away view of an electric heating element according to one or more aspects of the present invention;

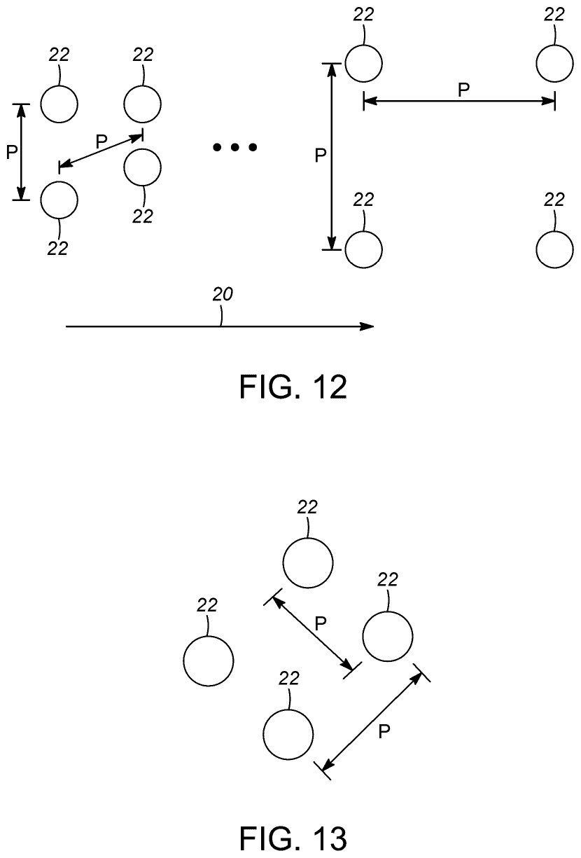

FIG. 12 is a side view of an arrangement of electric heating elements according to one or more aspects of the present invention;

FIG. 13 is a side view of an arrangement of electric heating elements according to one or more aspects of the present invention; and,

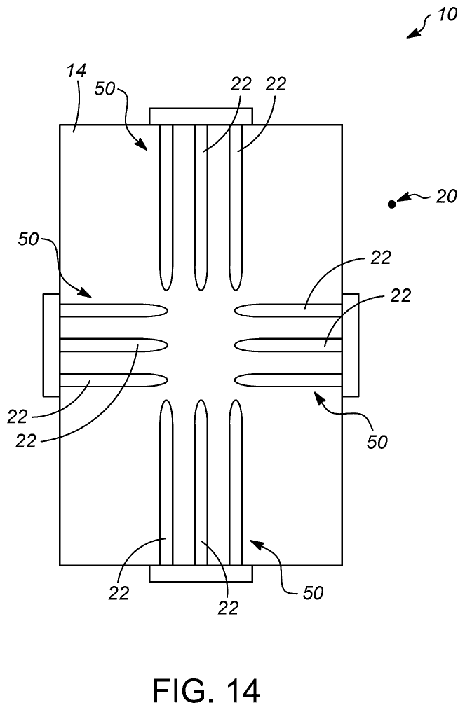

FIG. 14 is a top, cutaway view of an electric heater according to one or more aspects of the present invention.

### DETAILED DESCRIPTION OF THE INVENTION

As mentioned above, new designs for electric heaters and the electrical heating elements associated with same have been invented.

In some aspects, the present electric heaters and electrical heating elements reduce the internal (hot) volume of a heater for a given duty. Zones of different heat flux may be applied to the entire heater. The heating element surface heat flux may be throttled toward the outlet of the heater to keep the film temperature below the coking limit.

For temperature critical applications, local hotspots can be a concern. For example, local hotspots can initiate and/or accelerate coke formation in hydrocarbon process heating. When coke is formed on a heating element, additional thermal resistance impedes heat transfer to the motive fluid. For a constant power output resistive wire, this will increase a temperature of the resistive wire (or other heat generating element), amplifying the risk of premature element burnout. The buildup of coke deposits also plug flow paths, increasing hydraulic resistance over time. For process heaters, this increase in pressure drop may hinder performance in pressure sensitive applications.

Accordingly, in some aspects the present electric heaters and electrical heating elements have an adjusted the thermal conductivity of the dielectric packing to compensate for the variation in convection thermal resistance at the boundary of the heating element. Thus, regions where the local heat transfer coefficient is expected to be high may have sheath packing with relatively high thermal conductivity, while regions with a lower local heat transfer coefficient may have sheath packing with lower thermal conductivity. Surface temperatures would become more uniform in this arrangement which heat is directed to regions where heat is most easily transferred via convection.

Additionally, cylindrical shaped bundles of electric heaters are often housed in a hollowed cylindrical cavity that results in regions of non-uniform flow and extraneous hot volume. The proposed electric heaters and electrical heating elements mitigates this problem by more effectively utilizing the cavity space within the housing by providing a non-circular cavity or duct.

Most commercial scale electric process heaters are designed for circular flanges, with a cylindrical shaped heater bundle. A problem with this configuration when placed in either a hollow cylindrical cavity or a prismatic duct is that the flow prefers to bypass regions of high hydraulic resistance, leading to flow regions that are partially heated. This present invention solves this problem by utilizing, for example, a rectangular heater bundle geometry within a rectangular duct to limit any preferential flow or bypass. This ensures that the variation in heat transfer coefficient across the bundle geometry is significantly reduced, therefore modulating the heating element sheath surface temperature to below an experimentally determined fluid stream composition and sheath material composition specific limit and mitigating coking risk. A further benefit would be a reduced hot volume within the cavity, since void spaces occur when placing side-entry cylindrical heater bundles within a hollow cylindrical cavity vessel.

Additionally, subsonic flows in constant cross-sectional area ducts with heat addition experience density changes that may significantly accelerate the flow, particularly where large changes in enthalpy are present. In the context of flow over tube banks with fixed pitch, this progressive increase in velocity causes an overshoot in pressure drop when compared to constant density predictions. Electric heaters may be configured as a tube bank in cross-flow, and the strategies herein to control for pressure drop may be applied. These strategies may be important for processes that are sensitive to pressure and any cross-flow electric heater with a duty capable of imparting significant density changes to the fluid stream.

As the density of the fluid stream within the process heater decreases, if the open area is adjusted by increasing the heating element pitch gradually in direction of flow, a more uniform motive fluid velocity over heating elements may be maintained.

Additionally, heating elements such as a row(s) or ring(s) of heating element at the entrance of the cavity of the heater where resulting heat transfer coefficient is lower relative to downstream heating element potentially resulting in higher surface temperature of sheathed heating element(s) relative to downstream heating element. Additionally, heating elements such as a column(s) or a ring(s) of heating elements adjacent to wall of the cavity used to contain to be heated medium, where flowrate could be lower relative to other areas resulting potentially in lower heat transfer coefficient leading to higher skin temperature of sheathed heating element increasing the potential of general or metal catalyzed coking.

Further, the heater may be equipped with means, such as a sensor or probe, of determining a surface temperature of, for example, a sheathed heating element, which could be used to vary the current or voltage to the heating element in order to indirectly control the surface temperature of sheathed heating element.

With these general principles in mind, one or more embodiments of the present invention will be described with the understanding that the following description is not intended to be limiting.

Turning to FIGS. 1 and 2, in various aspects of the present invention, an electric heater 10 for heating a fluid stream is provided. The electric heater 10 has a body 12 with a cavity 14 inside of the body 12. The cavity 14 has an inlet end 16 configured to receive the fluid stream to be heated and an outlet end 18 to provide a heated fluid stream having a temperature that is higher than a temperature of the fluid stream introduced into the inlet end 16. Thus, within the cavity 14 the fluid flows in a direction of travel 20 that is from the inlet end 16 to the outlet end 18 (which is top to bottom in FIG. 1 and in and out of the paper in FIG. 2).

In order to heat the fluid within the cavity 14, a plurality of electrical heating elements 22 extend into the cavity 14. The electrical heating elements 22 are arranged along the direction of flow 20 meaning that as the fluid flows along the direction of travel 20, it passes the electrical heating elements 22. The electrical heating elements 22 may utilize resistive heating, or impedance heating, or both to convert electrical energy into heat energy.

According to various embodiments, the cavity 14 comprises at least two side walls 24a, 24b, 26a, 26b that extend parallel to each other. By “parallel” it is meant that to mean substantially parallel or that the axes are +/−45 degrees, or +/−40 degrees, or +/−30 degrees, or +/−15 degrees, or +/−10 degrees from being parallel. With respect to the embodiment of FIG. 2, the cavity has two sets of parallel side walls, walls 24a, 24b, and side walls 26a, 26b. Accordingly, when viewed along the direction of flow 20 (i.e., FIG. 2), the cavity 14 has a rectangular cross-sectional shape. Additionally, it is contemplated that at least two of the side walls 24a, 24b, 26a, 26b are planar walls. With planar side walls, longitudinal axes A1-A1 of the heating elements 22 may be substantially parallel with the walls 24a, 24b, or substantially perpendicular to the other two side walls 26a, 26b.

Turning to FIG. 3, it is also contemplated that the cavity 14 is formed in a radial flow design. The cavity 14 is defined between an inner screen 28 (e.g., a first porous wall) and an outer screen 30 (e.g., a second porous wall) which are substantially concentric, and may also include top and bottom walls that are parallel to each other. The fluid may flow from the center tube 32, through the cavity 14, to an outer annulus 34, or from the outer annulus 34, through the cavity 14, to the center tube 32. In other words, in such an embodiment, the direction of flow 20 may be radially inward or radially outward. The screens 28, 30 are considered parallel because they are substantially (i.e. +/−10%) equidistance from each other around the perimeter/circumference of the screens 28, 30. In this embodiment, the longitudinal axes A1-A1 of the heating elements 22 are perpendicular to the direction of flow 20. Such a configuration, in a radial flow, reduces hot volume.

As shown in FIGS. 1 and 2, an outer shape of the body 12 substantially matches the shape of the cavity 14. However, this is not required. For example, as shown in FIG. 4, the heater 10 has an outer shape that is circular (or cylindrical), while the side walls 24a, 24b, 26a, 26b of the cavity 14 form a rectangular shape. This can be achieved by fitting a material, such as a non-reactive, porous material or a metallic substrate, within the body 12 or by hollowing out a monolithic body 12 to form the cavity 14. This can also be achieved by forming side walls using metal as a shroud, and blocking flow outside of the shroud with a metal baffle, forcing all flow over the element bundles.

Turning to FIG. 5, it is contemplated that at least some of the electrical heating elements 22 are configured to be operated independently of the remaining electrical heating elements. This will allow the heating duty of the elements to be different from each other and to create a heat flux which changes within the cavity 14.

For example, a heat flux of the electrical heating elements 22 may generally decrease in the direction of flow 20 such that electrical heating elements 22 closer to the inlet end 16 have a higher heating flux than those closer to the outlet end 18 of the cavity 14. Similarly, a heat flux of one or more individual electrical heating elements 22 may change along a length of the electrical heating element 22. Even with an overall heat flux decreasing, it is possible that some electrical heating elements 22 have a heat flux that is different from the overall heat flux trend.

For example, electric heating elements 22 closest to the inlet end 16 (in box 36) may have a lower heat flux than the other electric heating elements 22 proximate the inlet end 16. Additionally, electric heating elements 22 closest to side walls 24 of the cavity 14 (in boxes 38) have a lower heat flux than the other electric heating elements 22 at the same or similar position along the direction of flow 20. These arrangements are believed to provide for efficient and effective heat transfer by focusing on areas where heat transfer is most likely to occur.

As shown in FIG. 6, the electrical heating elements 22 are arranged into a rectangular orientation. This orientation, especially when coupled with the rectangular shaped cavity 14 (e.g., FIGS. 1-3), is believed to provide for efficient and effective heat transfer by reducing empty space within the cavity 14. Again, such an orientation is merely preferred and not required.

With respect to the electric heating elements 22, the present invention provides various aspects and embodiments that are intended and believed to increase the effectiveness of the electric heater 10.

For example, as shown in FIG. 7, it is contemplated that an outer surface 40 of the electric heating elements 22 includes one or more detents 42. The detents 42 can be provided in a pattern or randomly. The detents 42 increase the surface area of the outer surface 40 to increase efficiency and effectiveness without creating too large of a pressure drop.

Turning to FIGS. 8 and 9, features of electrical heating element(s) 22 are shown in more detail. The electrical heating element 22 includes a heat generating substrate 44, like a metallic filament, a packing material 46 surrounding the heat generating substrate 44, and a sheath 48 surrounding the packing material 46.

In order to improve the effectiveness of the electric heater, the packing material 46 may be divided, when viewed along the longitudinal axis A1 of the electrical heating element 22, into a plurality of thermal conductivity zones 50a, 50b, 50c, 50d, 50e with different thermal conductivity levels. The thermal conductivity zones 50a, 50b, 50c, 50d, 50e may be arranged to have an increasing thermal conductivity along the direction of flow 20. Thus, the thermal conductivity zones 50a proximate the outer surface 40 that is first contacted by the fluid (at the left of FIG. 9) may have a relatively low thermal conductivity and as the fluid travels around the outer surface 40, the thermal conductivity of the thermal conductivity zones 50b, 50c, 50d, 50e may increase. Since the fluid can flow either on the upper or lower half, it is contemplated that the thermal conductivity zones 50a, 50b, 50c, 50d, 50e are arranged such that a horizontal cross section, when viewed along the longitudinal axis A1-A1, is a mirror image.

Turning to FIGS. 10 and 11, it is further contemplated that a distance from an outer surface of the heat generating substrate 44 to an inner surface of the sheath 48, when viewed along the longitudinal axis of element 22 (in and out of the paper in FIGS. 10 and 11), is non-constant. In other words, shown in FIG. 10 the sheath 48 may have, when viewed along the longitudinal axis A1-A1, a non-circular cross section, and the heat generating substrate 44 may have, when viewed along the longitudinal axis A1-A1, a circular cross section. Alternatively shown in FIG. 11, it is contemplated that the sheath 48 may have, when viewed along the longitudinal axis A1-A1, a circular cross section, and the heat generating substrate 44 has, when viewed along the longitudinal axis A1-A1, a non-circular cross section. While the depicted non-circular cross sections in FIGS. 10 and 11 are ovals with two axes of symmetry, other shapes are contemplated for example, an oval with one axis of symmetry, an airfoil (or tear drop) with one axis of symmetry a triangular, a rectangular, other regularly and irregularly shaped polygons. These non-circular cross-sectional configurations are believed to increase the effectiveness and efficiency of the heater by aligning, i.e., matching or tuning, the heat flux generated by the heating element to heat transfer coefficient around the circumference or perimeter of the electric heating element.

In any of the foregoing embodiments, it is contemplated that the sheath 48 may include a FeCrAl alloy forming the outer surface 40. The presence of aluminum and chromium allows formation of adherent protective surface film. Small additions of reactive elements, such as yttrium, hafnium, and cerium, may substantially improve the adherence of protective film specifically at high temperatures. The aluminum content should be greater than 4% to allow continuous formation of protective layer. Additionally, the absence of nickel in FeCrAl based metal should directionally reduce the potential for metal catalyzed coking as nickel is known to catalyze chemical reactions.

FeCrAl based material are also highly resistant to steam, oxidation, carburization, metal dusting sulfur, halogen induced stress corrosion cracking, and low hydrogen permeation so then can be used in variety of services. High Cr-Ferritic steel is generally resistant to grain boundary sensitization (carbide precipitation chromium depletion).

Alternatively, the sheath 48 may include 347AP stainless steel forming the outer surface 40. Alternatively, or additionally, internal surfaces within the heater 10 may also be formed 347AP stainless steel.

If stainless steel in process equipment is exposed to temperatures above 425° C. (via welding, process conditions, etc.), grain boundaries become depleted of chromium over time, which makes stainless steel more susceptible to corrosion, a phenomenon known as sensitization. These conditions increase the risk of polythionic acid stress corrosion cracking (PASCC) in stainless steel process equipment. 347 stainless steel, a niobium stabilized austenitic stainless steel, has superior intergranular corrosion resistance compared to other stainless steel alloys. Though 347 stainless steel is less susceptible to PASCC than other stainless-steel alloys, it is still not immune, and care must be taken at startup and shutdown to prevent PASCC. A modified 347 stainless steel, 347AP, was developed with high sensitization resistance to remove the need for costly neutralization steps during maintenance. Accordingly, one or more internal surfaces (element sheaths, baffles, vessel shell, etc.) may be formed from 347AP stainless steel, which has a very low carbon content (0.007% mass-percent) and a very high niobium to carbon ratio (Nb:0.31% mass-percent).

Additionally, as noted above, a material may be affixed to some of the interior surfaces of the body 12, for example to form the cavity 14. Accordingly, such interior surfaces, like a surface of a wall, or other surface within the cavity 14 may be coated with an aluminum coating. Alternatively, or additionally, the outer surface 40 of the sheath 48 may be coated with an aluminum coating.

Turning to FIGS. 12 and 13, the spacing between adjacent electrical heating elements 22, or the pitch P, is shown as changing along a direction of flow 20, for example as increasing. This is not necessarily required, and it is possible that the pitch P may decrease or stay the same. Generally, the pitch P may be between 0.25 inches to 12 inches, for example, 0.5 inches.

Preferably, the electrical heating elements 22 have a pitch P that is rectangular (FIG. 12) or rotated rectangular (FIG. 13). Heating elements arranged in a triangular pitch have enhanced heat transfer by promoting turbulence. However, triangular pitched heating elements are difficult to access with hydroblasting and are generally avoided in fouling services. A square or rectangular pitch for the heating elements has the advantage of being easily hydroblasted to remove fouling deposits. The reduced heat transfer coefficient associated with square pattern tubes means that more tubes are required for the same temperature driving force. Larger tube spacings also mitigate fouling concerns, as deposits can bridge small pitch spacings overtime, which may lead to heating elements to burnout prematurely by increasing the heat transfer resistance at the sheath surface and disrupting flow paths.

In order to operate the electric heater 10, the electrical heating elements 22 may be arranged in bundles 50. See, FIGS. 1, 5, and 6. Two or more of the bundles 50 may be configured to be operated together (or non-independently) by the same controller. This may reduce the number of controllers needed to control large electric heaters with multiple bundles.

Returning to FIGS. 1 and 2, the electrical heating elements 22 may have different directions of insertion into the cavity 14. For example, the directions of insertion may alternate for adjacent electrical heating elements 22 (or bundles 50). By alternate it is meant that the directions of insertion repeat in a pattern. It is further contemplated that, as shown in FIG. 14 the directions of insertion, when viewed along the direction of flow, rotate by between 1 to 179 degrees, or between 20 to 160 degrees, or approximately 90 degrees.

As shown in FIG. 1, at least one temperature sensor 52 may be included in the electric heater 10. The temperature sensor 52 may be configured to obtain a temperature measurement associated with the electric heater 10, which may be temperature of the fluid at the inlet end 16, at the outlet end 18, a surface temperature of the outer surface 40 of one or more of the electrical heating elements 22, etc. The sensor 52 may be in communication with a controller 54, or computing devices or systems, which includes at least one processor and memory storing computer-readable instructions that, when executed by the at least one processor, cause the one or more computing devices to perform a process that may include one or more steps. For example, the one or more computing devices may be configured to receive, from the temperature sensor 52, temperature data related to the electric heater. The controller 54 may be configured to analyze the data. Based on analyzing the data, the controller 54 may be configured to determine one or more recommended adjustments to one or more parameters associated with the electric heater 10 including adjustment of a thermal flux of one or more electrical heating elements 22 (or bundles 50 thereof). The controller 54 may be configured to transmit encrypted or unencrypted data that includes the one or more recommended adjustments to the electric heater 10 including for example a flow rate associated with the electrical heater 10.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be utilized to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps.

For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

### SPECIFIC EMBODIMENTS

While the following is described in conjunction with specific embodiments, it will be understood that this description is intended to illustrate and not limit the scope of the preceding description and the appended claims.

A first embodiment of the invention is an electric heater for heating a fluid stream, the electric heater comprising a body with an inlet and an outlet and a cavity between the inlet and outlet; and, a plurality of electrical heating elements extending into the cavity, the electrical heating elements arranged along a direction of flow from the inlet to the outlet, wherein at least some of the electrical heating elements are configured to be operated independently of the remaining electrical heating elements, and, wherein the cavity comprises a first side wall that extends parallel to a second side wall. An embodiment of the invention is one, any or all of prior embodiments in this paragraph up through the first embodiment in this paragraph, wherein a heat flux of the electrical heating elements decreases in the direction of flow such that an electrical heating element closer to the inlet has a higher heat flux compared to an electrical heating element farther from the inlet. An embodiment of the invention is one, any or all of prior embodiments in this paragraph up through the first embodiment in this paragraph, wherein electric heating elements closest to the inlet have a lower heat flux than the other electric heating elements. An embodiment of the invention is one, any or all of prior embodiments in this paragraph up through the first embodiment in this paragraph, wherein electric heating elements closest to side walls of the cavity have a lower heat flux than the other electric heating elements. An embodiment of the invention is one, any or all of prior embodiments in this paragraph up through the first embodiment in this paragraph, wherein the first and second side walls are planar. An embodiment of the invention is one, any or all of prior embodiments in this paragraph up through the first embodiment in this paragraph, wherein the cavity has a cross sectional shape along the direction of flow that is rectangular. An embodiment of the invention is one, any or all of prior embodiments in this paragraph up through the first embodiment in this paragraph, wherein an outer shape of the body is circular. An embodiment of the invention is one, any or all of prior embodiments in this paragraph up through the first embodiment in this paragraph, wherein one or more of the electrical heating elements comprises an outer surface that comprises a plurality of detents. An embodiment of the invention is one, any or all of prior embodiments in this paragraph up through the first embodiment in this paragraph, wherein one or more of the electrical heating elements comprises a heat generating substrate; a packing material surrounding the heat generating substrate; a sheath surrounding the packing material; a longitudinal axis, wherein the packing material is divided, when viewed along the longitudinal axis, into a plurality of thermal conductivity zones, with adjacent thermal conductivity zones having different thermal conductivity levels. An embodiment of the invention is one, any or all of prior embodiments in this paragraph up through the first embodiment in this paragraph, wherein the thermal conductivity zones are arranged such that a horizontal cross section, when viewed along the longitudinal axis, is a mirror image. An embodiment of the invention is one, any or all of prior embodiments in this paragraph up through the first embodiment in this paragraph, wherein the thermal conductivity zones are arranged to have an increasing thermal conductivity. An embodiment of the invention is one, any or all of prior embodiments in this paragraph up through the first embodiment in this paragraph, wherein one or more of the electrical heating elements comprises a heat generating substrate; a packing material surrounding the heat generating substrate; a sheath surrounding the packing material; a longitudinal axis, wherein the sheath has, when viewed along the longitudinal axis, a circular cross section, and the heat generating substrate has, when viewed along the longitudinal axis, a non-circular cross section. An embodiment of the invention is one, any or all of prior embodiments in this paragraph up through the first embodiment in this paragraph, wherein one or more of the electrical heating elements comprises a heat generating substrate; a packing material surrounding the heat generating substrate; a sheath surrounding the packing material; a longitudinal axis, wherein the sheath has, when viewed along the longitudinal axis, a non-circular cross section, and the heat generating substrate has, when viewed along the longitudinal axis, a circular cross section. An embodiment of the invention is one, any or all of prior embodiments in this paragraph up through the first embodiment in this paragraph, wherein one or more of the electrical heating elements comprises a heat generating substrate; a packing material surrounding the heat generating substrate; a sheath surrounding the packing material; a longitudinal axis, wherein a distance from an outer surface of the heat generating substrate to an inner surface of the sheath, when viewed along the longitudinal axis, is non-constant. An embodiment of the invention is one, any or all of prior embodiments in this paragraph up through the first embodiment in this paragraph, wherein the electrical heating elements are arranged into a rectangular orientation. An embodiment of the invention is one, any or all of prior embodiments in this paragraph up through the first embodiment in this paragraph, wherein each electrical heating element comprises a heat generating substrate and a sheath surrounding the heat generating substrate, wherein the sheath comprises a FeCrAl alloy forming an outer surface. An embodiment of the invention is one, any or all of prior embodiments in this paragraph up through the first embodiment in this paragraph, comprising at least one internal surface comprising a 347AP stainless steel. An embodiment of the invention is one, any or all of prior embodiments in this paragraph up through the first embodiment in this paragraph, wherein each electrical heating element comprises a heat generating substrate and a sheath surrounding the heat generating substrate, wherein the sheath comprises the 347AP stainless steel. An embodiment of the invention is one, any or all of prior embodiments in this paragraph up through the first embodiment in this paragraph, wherein a pitch between electrical heating elements changes along the direction of flow. An embodiment of the invention is one, any or all of prior embodiments in this paragraph up through the first embodiment in this paragraph, further comprising a pitch, in a rectangular orientation, between electrical heating elements is between 0.25 inches to 12 inches, for example, 0.5 inches. An embodiment of the invention is one, any or all of prior embodiments in this paragraph up through the first embodiment in this paragraph, wherein the electrical heating elements are arranged in bundles, and wherein at least two bundles are configured to be operated together. An embodiment of the invention is one, any or all of prior embodiments in this paragraph up through the first embodiment in this paragraph, wherein the electrical heating elements have different directions of insertion into the cavity. An embodiment of the invention is one, any or all of prior embodiments in this paragraph up through the first embodiment in this paragraph, wherein the directions of insertion alternate for adjacent electrical heating elements. An embodiment of the invention is one, any or all of prior embodiments in this paragraph up through the first embodiment in this paragraph, wherein the directions of insertion, when viewed along the direction of flow, rotate by between 1 to 179 degrees, or between 20 to 160 degrees, or approximately 90 degrees. An embodiment of the invention is one, any or all of prior embodiments in this paragraph up through the first embodiment in this paragraph, wherein the direction of flow is radially inward or radially outward. An embodiment of the invention is one, any or all of prior embodiments in this paragraph up through the first embodiment in this paragraph, further comprising at least one temperature sensor configured to obtain a temperature measurement associated with the electric heater. An embodiment of the invention is one, any or all of prior embodiments in this paragraph up through the first embodiment in this paragraph, further comprising at least one internal surface coated with an aluminum coating. An embodiment of the invention is one, any or all of prior embodiments in this paragraph up through the first embodiment in this paragraph, wherein each electrical heating element comprises a heat generating substrate and a sheath surrounding the heat generating substrate, wherein an aluminum-containing barrier coating is applied to the sheath.

A second embodiment of the invention is an apparatus for heating a fluid stream, the electric heater comprising a body with an inlet and an outlet and a cavity between the inlet and outlet; and, a plurality of electrical heating elements extending into the cavity, the electrical heating elements arranged along a direction of flow from the inlet to the outlet, wherein at least some of the electrical heating elements are configured to be operated independently of the remaining electrical heating elements, and, wherein the cavity comprises a first side wall that extends parallel to a second side wall. An embodiment of the invention is one, any or all of prior embodiments in this paragraph up through the second embodiment in this paragraph, wherein a heat flux of the electrical heating elements decreases in the direction of flow such that an electrical heating element closer to the inlet has a higher heat flux compared to an electrical heating element farther from the inlet, or wherein the electric heating elements closest to the inlet have a lower heat flux than the other electric heating elements, or wherein the electric heating elements closest to side walls of the cavity have a lower heat flux than the other electric heating elements, or wherein a heat flux of at least one electrical heating element changes along a length of the at least one electrical heating element. An embodiment of the invention is one, any or all of prior embodiments in this paragraph up through the second embodiment in this paragraph, wherein the first and second side walls are planar. An embodiment of the invention is one, any or all of prior embodiments in this paragraph up through the second embodiment in this paragraph, wherein the cavity has a cross sectional shape along the direction of flow that is a parallelogram. An embodiment of the invention is one, any or all of prior embodiments in this paragraph up through the second embodiment in this paragraph, wherein an outer shape of the body is circular. An embodiment of the invention is one, any or all of prior embodiments in this paragraph up through the second embodiment in this paragraph, wherein one or more of the electrical heating elements comprises an outer surface that comprises a plurality of detents. An embodiment of the invention is one, any or all of prior embodiments in this paragraph up through the second embodiment in this paragraph, wherein one or more of the electrical heating elements comprises a heat generating substrate; a packing material surrounding the heat generating substrate; a sheath surrounding the packing material; a longitudinal axis, wherein the packing material is divided, when viewed along the longitudinal axis, into a plurality of thermal conductivity zones, with adjacent thermal conductivity zones having different thermal conductivity levels. An embodiment of the invention is one, any or all of prior embodiments in this paragraph up through the second embodiment in this paragraph, wherein the thermal conductivity zones are arranged such that a horizontal cross section, when viewed along the longitudinal axis, is a mirror image. An embodiment of the invention is one, any or all of prior embodiments in this paragraph up through the second embodiment in this paragraph, wherein the thermal conductivity zones are arranged to have an increasing thermal conductivity. An embodiment of the invention is one, any or all of prior embodiments in this paragraph up through the second embodiment in this paragraph, wherein one or more of the electrical heating elements comprises a heat generating substrate; a packing material surrounding the heat generating substrate; a sheath surrounding the packing material; a longitudinal axis, wherein one of the sheath and the heat generating substrate has, when viewed along the longitudinal axis, a circular cross section, and the other of the sheath and the heat generating substrate has, when viewed along the longitudinal axis, a non-circular cross section. An embodiment of the invention is one, any or all of prior embodiments in this paragraph up through the second embodiment in this paragraph, wherein one or more of the electrical heating elements comprises a heat generating substrate; a packing material surrounding the heat generating substrate; a sheath surrounding the packing material; a longitudinal axis, wherein a distance from an outer surface of the heat generating substrate to an inner surface of the sheath, when viewed along the longitudinal axis, is non-constant. An embodiment of the invention is one, any or all of prior embodiments in this paragraph up through the second embodiment in this paragraph, wherein the electrical heating elements are arranged into a rectangular orientation. An embodiment of the invention is one, any or all of prior embodiments in this paragraph up through the second embodiment in this paragraph, wherein each electrical heating element comprises a heat generating substrate and a sheath surrounding the heat generating substrate, wherein the sheath comprises a FeCrAl alloy forming an outer surface or wherein an aluminum-containing barrier coating is applied to the sheath. An embodiment of the invention is one, any or all of prior embodiments in this paragraph up through the second embodiment in this paragraph, comprising at least one internal surface comprising a 347AP stainless steel or at least one internal surface coated with an aluminum coating or both. An embodiment of the invention is one, any or all of prior embodiments in this paragraph up through the second embodiment in this paragraph, wherein each electrical heating element comprises a heat generating substrate and a sheath surrounding the heat generating substrate, wherein the sheath comprises the 347AP stainless steel. An embodiment of the invention is one, any or all of prior embodiments in this paragraph up through the second embodiment in this paragraph, wherein a pitch between electrical heating elements changes along the direction of flow, or wherein a pitch, in a rectangular orientation, between electrical heating elements is between 0.25 inches to 12 inches, for example, 0.5 inches. An embodiment of the invention is one, any or all of prior embodiments in this paragraph up through the second embodiment in this paragraph, wherein the electrical heating elements are arranged in bundles, and wherein at least two bundles are configured to be operated together. An embodiment of the invention is one, any or all of prior embodiments in this paragraph up through the second embodiment in this paragraph, wherein the electrical heating elements have different directions of insertion into the cavity and, optionally, wherein the directions of insertion alternate for adjacent electrical heating elements and optionally, wherein the directions of insertion, when viewed along the direction of flow, rotate by between 1 to 179 degrees, or between 20 to 160 degrees, or approximately 90 degrees. An embodiment of the invention is one, any or all of prior embodiments in this paragraph up through the second embodiment in this paragraph, wherein the direction of flow is radially inward or radially outward. An embodiment of the invention is one, any or all of prior embodiments in this paragraph up through the second embodiment in this paragraph, further comprising at least one temperature sensor configured to obtain a temperature measurement associated with the electric heater.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An electric heater for heating a fluid stream, the electric heater comprising:
a body with an inlet and an outlet and a cavity between the inlet and outlet; and,
a plurality of electrical heating elements extending into the cavity, the electrical heating elements arranged along a direction of flow from the inlet to the outlet,
wherein at least some of the electrical heating elements are configured to be operated independently of the remaining electrical heating elements, and,
wherein the cavity comprises a first side wall that extends parallel to a second side wall.

2. The electric heater of claim 1, wherein a heat flux of the electrical heating elements decreases in the direction of flow such that an electrical heating element closer to the inlet has a higher heat flux compared to an electrical heating element farther from the inlet, or
wherein the electric heating elements closest to the inlet have a lower heat flux than the other electric heating elements, or
wherein the electric heating elements closest to side walls of the cavity have a lower heat flux than the other electric heating elements, or
wherein a heat flux of at least one electrical heating element changes along a length of the at least one electrical heating element.

3. The electric heater of claim 1, wherein the first and second side walls are planar.

4. The electric heater of claim 1, wherein the cavity has a cross sectional shape along the direction of flow that is a parallelogram.

5. The electric heater of claim 1, wherein an outer shape of the body is circular.

6. The electric heater of claim 1, wherein one or more of the electrical heating elements comprises an outer surface that comprises a plurality of detents.

7. The electric heater of claim 1, wherein one or more of the electrical heating elements comprises:
a heat generating substrate;
a packing material surrounding the heat generating substrate;
a sheath surrounding the packing material;
a longitudinal axis,
wherein the packing material is divided, when viewed along the longitudinal axis, into a plurality of thermal conductivity zones, with adjacent thermal conductivity zones having different thermal conductivity levels.

8. The electric heater of claim 7, wherein the thermal conductivity zones are arranged such that a horizontal cross section, when viewed along the longitudinal axis, is a mirror image.

9. The electric heater of claim 7, wherein the thermal conductivity zones are arranged to have an increasing thermal conductivity.

10. The electric heater of claim 1, wherein one or more of the electrical heating elements comprises:
a heat generating substrate;
a packing material surrounding the heat generating substrate;
a sheath surrounding the packing material;
a longitudinal axis,
wherein one of the sheath and the heat generating substrate has, when viewed along the longitudinal axis, a circular cross section, and the other of the sheath and the heat generating substrate has, when viewed along the longitudinal axis, a non-circular cross section.

11. The electric heater of claim 1, wherein one or more of the electrical heating elements comprises:
a heat generating substrate;
a packing material surrounding the heat generating substrate;
a sheath surrounding the packing material;
a longitudinal axis,
wherein a distance from an outer surface of the heat generating substrate to an inner surface of the sheath, when viewed along the longitudinal axis, is non-constant.

12. The electric heater of claim 1, wherein the electrical heating elements are arranged into a rectangular orientation.

13. The electric heater of claim 1, wherein each electrical heating element comprises a heat generating substrate and a sheath surrounding the heat generating substrate, wherein the sheath comprises a FeCrAl alloy forming an outer surface or wherein an aluminum-containing barrier coating is applied to the sheath.

14. The electric heater of claim 1, comprising at least one internal surface comprising a 347AP stainless steel or at least one internal surface coated with an aluminum coating or both.

15. The electric heater of claim 14, wherein each electrical heating element comprises a heat generating substrate and a sheath surrounding the heat generating substrate, wherein the sheath comprises the 347AP stainless steel.

16. The electric heater of claim 1, wherein a pitch between electrical heating elements changes along the direction of flow, or
wherein a pitch, in a rectangular orientation, between electrical heating elements is between 0.25 inches to 12 inches, for example, 0.5 inches.

17. The electric heater of claim 1, wherein the electrical heating elements are arranged in bundles, and
wherein at least two bundles are configured to be operated together.

18. The electric heater of claim 1, wherein the electrical heating elements have different directions of insertion into the cavity and, optionally, wherein the directions of insertion alternate for adjacent electrical heating elements and optionally, wherein the directions of insertion, when viewed along the direction of flow, rotate by between 1 to 179 degrees, or between 20 to 160 degrees, or approximately 90 degrees.

19. The electric heater of claim 1, wherein the direction of flow is radially inward or radially outward.

20. The electric heater of claim 1, further comprising:
at least one temperature sensor configured to obtain a temperature measurement associated with the electric heater.
